(19) United States
(12) Patent Application Publication
(10) Pub. No.: US 2009/0048900 A1
(43) Pub. Date: Feb. 19, 2009

(54) Method and System For Tracking and Optimizing Advertisements on a Decentralized Network

(75) Inventor: James E. Moore, Hadleigh (GB)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Macrovision Corporation

(21) Appl. No.: 11/838,767

(22) Filed: Aug. 14, 2007

(51) Int. Cl. G06F 17/30; G06Q 99/00

(52) U.S. Cl. 705/10; 707/10; 707/3

(57) ABSTRACT

A method and system for tracking and optimizing advertisements on a decentralized network. In one embodiment, the method comprises receiving a request for a user from a user on a network. The method further comprises responding to the request by transmitting the file to the user, the file containing an identifier. The identifier is used to track the user's treatment of the file.

### FIELD OF THE INVENTION

The field of the invention relates generally to computer systems and more particularly relates to a method and system for tracking and optimizing advertisements on a decentralized network.

### BACKGROUND OF THE INVENTION

Peer-to-peer file sharing is a data exchange infrastructure that allows the exchange of information between computers without a central network structure. Every machine connected to the peer-to-peer network contains client and server capability to both request information from and serve information to other machines of similar configuration. Such networks are organized loosely without any centralized management authority. This allows for any user to attach to the network and share files. It also allows for any user to request shared files from other users having similar characteristics.

Currently, advertising is not effective in many modern peer-to-peer networks. On privately developed peer-to-peer networks, advertising is often limited to companies that pay the owner of the network for banner-based ads. On open source developed peer-to-peer networks, advertising may not be permitted. Furthermore, even if advertising is permitted, advertisements are usually not targeted toward the users' needs or desires. This type of advertising annoys peer-to-peer users because it results in slower connections and wasted time. It is counterproductive for advertisers because they lose money on each advertisement and possibly receive negative publicity or exposure. There is also lacking a way to track users' treatment of files shared on a peer-to-peer network and to develop statistics on such user treatment to optimize advertising and monetization efforts on the network.

### SUMMARY

A method and system for tracking and optimizing advertisements on a decentralized network. In one embodiment, the method comprises receiving a request for a user from a user on a network. The method further comprises responding to the request by transmitting the file to the user, the file containing an identifier. The identifier is used to track the user's treatment of the file.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates a node diagram of a non-hierarchical decentralized network, according to one embodiment.

FIG. 2 illustrates a node diagram of a hierarchical decentralized network, according to one embodiment.

FIG. 3 illustrates a flow diagram of a method for performing a search query in a non-hierarchical decentralized network, according to one embodiment.

FIG. 4 illustrates a flow diagram of a method for performing a search query performed by a regular node in a hierarchical decentralized network, according to one embodiment.

FIG. 5 illustrates a flow diagram of a method for performing a search query performed by a SuperNode in a hierarchical decentralized network, according to one embodiment.

FIG. 6 illustrates a block diagram of a system utilizing aspects of the present invention for interdicting search queries in a decentralized network, according to one embodiment.

FIG. 7 illustrates a flow diagram of a method for interdicting search queries through search result manipulation, according to one embodiment.

FIG. 8 illustrates a flow diagram of a method for quarantining a node, according to one embodiment.

FIGS. 9-12 illustrate nodal diagrams as an example of the method for quarantining a node, according to one embodiment.

FIG. 13 illustrates a flow diagram of a method for interdicting search queries through file impersonation, according to one embodiment.

FIG. 14 illustrates a flow diagram of a method for interdicting search queries through file transfer attenuation, according to one embodiment.

FIG. 15 illustrates a flow diagram of a demand based method for interdicting unauthorized copying in a decentralized network, according to one embodiment.

FIG. 16 illustrates a flow diagram of a preferred embodiment of a demand based method for interdicting unauthorized copying in a decentralized network, according to one embodiment.

FIG. 17 illustrates a block diagram of an apparatus for performing a demand based method for interdicting unauthorized copying in a decentralized network before connecting a controlled node, according to one embodiment.

FIG. 18 illustrates a block diagram of an apparatus for performing a demand based method for interdicting unauthorized copying in a decentralized network after connecting a controlled node, according to one embodiment.

FIG. 19 illustrates a block diagram of a system for tracking and optimizing advertisements on a decentralized network, according to one embodiment.

FIG. 20 illustrates a flow diagram of a method for tracking and optimizing advertisements on a decentralized network, according to one embodiment.

FIG. 21 illustrates a flow diagram of a method for tracking and optimizing advertisements on a decentralized network, according to one embodiment.

FIG. 22 illustrates an exemplary computer architecture for use with the present according to one embodiment.

### DETAILED DESCRIPTION

A method and system for tracking and optimizing advertisements on a decentralized network. In one embodiment, the method comprises receiving a request for a user from a user on a network. The method further comprises responding to the request by transmitting the file to the user, the file containing an identifier. The identifier is used to track the user's treatment of the file.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

In a decentralized network, there is no central authority or managing entity. Each node of the network makes decisions autonomously to connect, disconnect, and share information with other nodes in the network according to a predetermined protocol established by the creators of the network. Files and documents are stored in the nodes of the networks and propagated throughout the network via inter-nodal exchange. Users search the network using search queries at their respective nodes for specific files or documents and then select a host from search results to download or stream the content from.

To illustrate the various aspects of the present invention, two networks, respectively referred to as Type A and Type B networks, are used as examples throughout the following description.

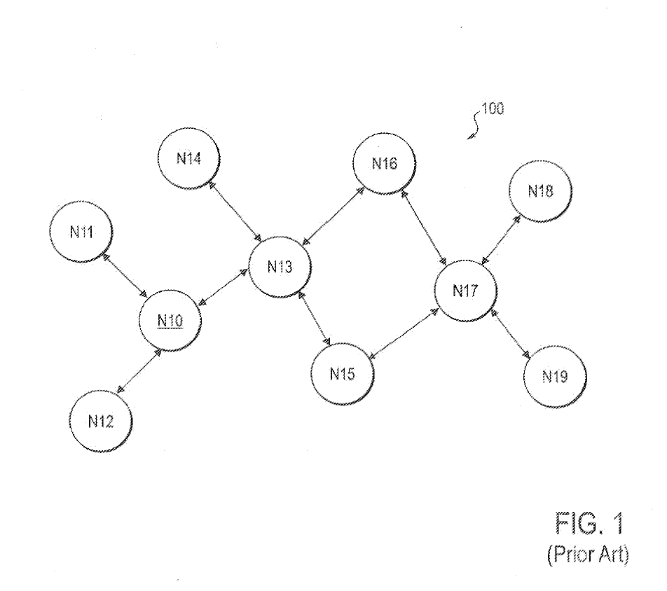

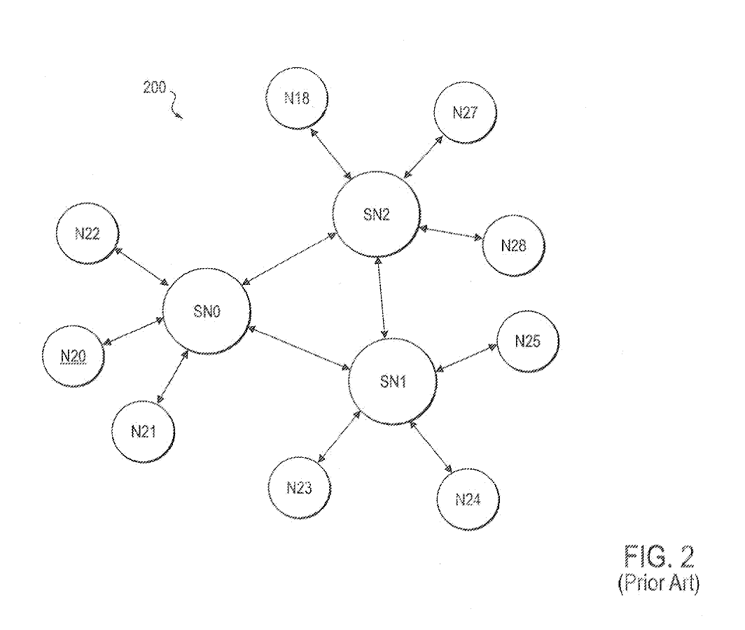

FIG. 1 illustrates, as an example, a node diagram of a Type A, non-hierarchical decentralized network 100. In this network structure, all nodes such as nodes N11 to N19 are treated as equals. FIG. 2, on the other hand, illustrates, as an example, a node diagram of a Type B, hierarchical decentralized network 200. In this second network, there are regular nodes such as nodes N20 to N28, and so-called SuperNodes such as SuperNodes SN0 to SN2. Regular nodes represent computers hooked to the network 200 that host or are capable of hosting files for sharing. SuperNodes are computers hooked to the network 200 that not only host or are capable of hosting files for sharing, but also have higher resources than regular nodes and generally perform functions in addition to those of regular nodes.

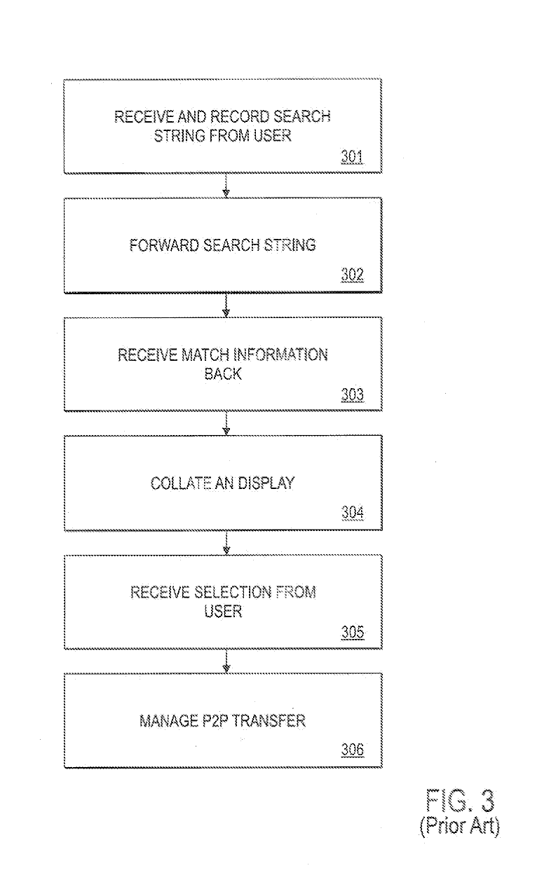

FIG. 3 illustrates a flow diagram of a method for performing a file or document search in a Type A, non-hierarchical decentralized network such as the network 100. In 301, when a user of a node (such as node N10 in FIG. 1) initiates a search by generating a search (or keyword) string, the node operated by the user (hereinafter referred to as the “client node”) receives and records that search string. In some systems, the name of a file that is being requested is hashed to get a key or hash value, and the key or hash value is sent out in the search string for matching.

In 302, the client node then forwards the search string to other nodes in the decentralized network. It may do this, for example, by forwarding the search string to one or more of its neighboring nodes (i.e., nodes that it is in communication with through the decentralized network software, such as nodes N11, N12 and N13 with respect to node N10 in FIG. 1), which in turn, forward the search string to their neighboring nodes (such as nodes N14, N15 and N16 with respect to node N13 in FIG. 1), and so on, throughout the decentralized network. Note that the precise behavior of the search string handling, forwarding and query match returning process depends on the defined rules and/or policies of the decentralized network.

Each node receiving the search string checks its file list for matches, and sends information of any query matches back through the decentralized network so as to be received by the client node in 303. Information of the query matches includes information on how to locate the file such as an URL. Hash values for each of the references (i.e., files or documents) may also be sent in the query matches. All query matches (also referred to herein as “search results”) are generally sent back along the path that they came.

In 304, all received query matches are collated and displayed on a display screen by the client node for its user. In 305, the client node receives a selection (i.e., file or document) indicated by its user, and in 306, it manages a P2P transfer with the selected file's host node(s). For example, the client node may establish a direct connection with the node(s) having a copy of the selection available for download, and sends an HTTP request to those node(s) requesting the selection. The node(s) may then reply with a standard HTTP response.

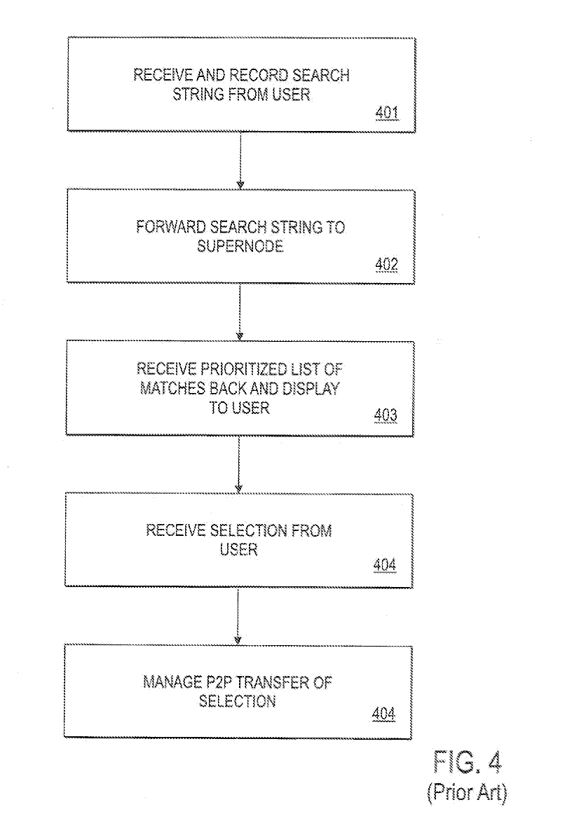

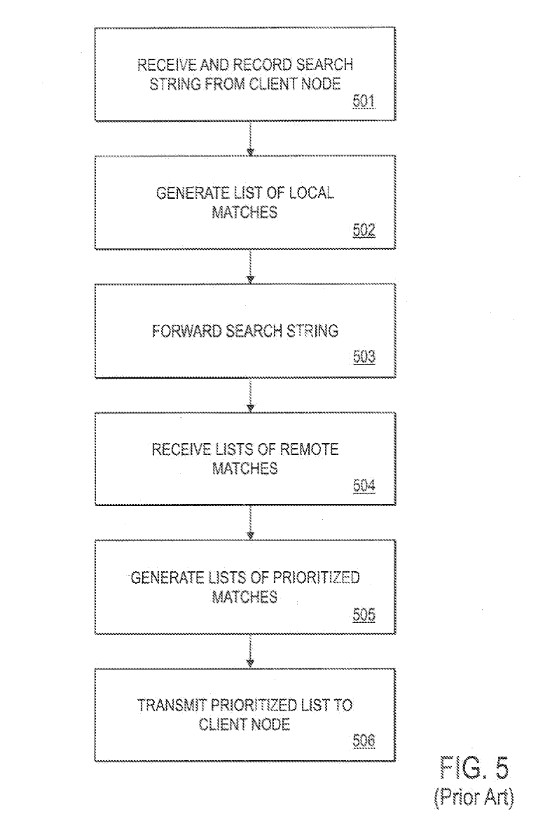

FIGS. 4-5 illustrate a flow diagram of a method for performing a search query in a Type B, hierarchical decentralized network such as the network 200. In particular, FIG. 4 illustrates actions taken by a client node initiating the search string (such as node N20 in FIG. 2), and FIG. 5 illustrates corresponding actions taken by a SuperNode (such as SuperNode SN0 connected to node N20 in FIG. 2) receiving the search string.

Referring now to FIG. 4, in 401, when a user of a node (such as node N20) initiates a search by generating a search (or keyword) string, the node operated by the user (i.e., the “client node”) receives and records that search string. In 402, the client node then forwards the search string to a SuperNode (such as SN0), which in turn, performs activities described in reference to FIG. 5. In 403, the client node receives a prioritized list of matches back from the SuperNode and displays it on a display screen of the client node. In 404, the client node receives a selection indicated by its user, and in 405, it manages a P2P transfer with the selected file's host node(s) in much the same fashion as described in reference to 305 of FIG. 3.

Referring now to FIG. 5, in 501, a SuperNode receives and records the search string from the client node. In 502, it checks the search string against its file list, which includes files that it hosts as well as files available on other nodes connected to it (such as regular nodes N22 and N21 connected to SuperNode SN0) to generate a list of local matches. In 503, it forwards the search string to all or a subset of SuperNodes connected to it (such as SuperNodes SN1 and SN2 connected to SuperNode SN0). These SuperNodes may in turn forward the search string to other SuperNodes connected to them, and so on, wherein the number of levels the search string is forwarded depends on the defined rules and/or policies of the decentralized network.

Each of the SuperNodes receiving the search string then checks its file list for matches, and sends information of query matches (as lists of local matches) back through the decentralized network so as to be received by the original SuperNode in 504. In 505, the original SuperNode (i.e., the SuperNode first receiving the search string) then generates a list of prioritized matches from all the lists of local matches (including its own). Prioritization in this case is commonly done, for example, by connection speed and quality of the file. Finally, in 506, the prioritized list of matches is transmitted back to the client node from which the search string originated.

Additional details on decentralized networks may be found from publicly available information for decentralized peer-to-peer technologies and protocols such as Freenet, GNUtella, and Fastrack, wherein detailed knowledge of each such decentralized network is useful in implementing the various aspects of the present invention.

Interdiction System

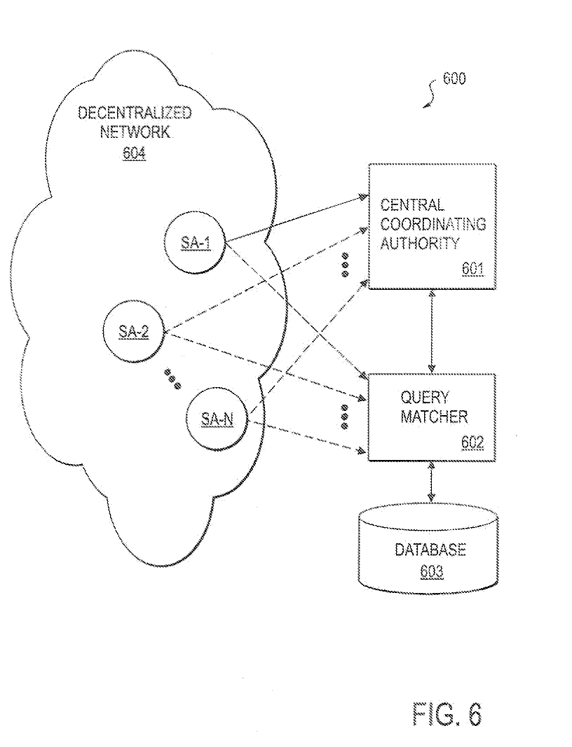

FIG. 6 illustrates a block diagram of a system 600 for interdicting unauthorized copying in a Decentralized Network 604. A plurality of Software Agents SA-1 to SA-N are infiltrated into the Decentralized Network 604 masquerading as nodes by following all the traditions and policies of the Decentralized Network 604 so that they are virtually indistinguishable as infiltrators.

The Software Agents SA-1 to SA-N are implemented as software residing on one or more computers that communicate with nodes in the Decentralized Network 604 through individually assigned ports of the one or more computers. IP addresses for the ports may vary with time or in some other manner so that detection of the Software Agents SA-1 to SA-N as unauthorized masqueraders of nodes in the Decentralized Network 604 and their expulsion from the Network 604 are prevented or at least made considerably more difficult.

The Software Agents SA-1 to SA-N may uniformly infiltrate the Decentralized Network 604 by, for example, each of the Software Agents SA-1 to SA-N connecting to a corresponding node of a representative set of nodes in the Decentralized Network 604. The representative set of nodes in this case is a subset of the Decentralized Network 604 from which characteristics of the entire Decentralized Network 604 may be statistically inferred.

General steps used by the Software Agents SA-1 to SA-N to infiltrate the Decentralized Network 604 include making Internet connections to other nodes in the Decentralized Network 604, performing handshakes or login procedures with those other nodes as specified by the protocol of the Decentralized Network 604 in order to be recognized as nodes of the Decentralized Network 604, and conducting searches and performing operations that regular nodes routinely do in the Decentralized Network 604 while clandestinely also performing interdiction functions.

In addition, if the Software Agents SA-1 to SA-N are to masquerade as Supernodes in the Decentralized Network 604, they also inform the Decentralized Network 604 that they are Supernodes upon logging in and/or they are configured or at least inform the Decentralized Network 604 that they are configured to meet all of the criteria for a Supernode according to the policies of the Decentralized Network 604.

In order to perform the above infiltration, it is useful to first identify nodes in the Decentralized Network 604 that the Software Agents SA-1 to SA-N can make Internet connections to. One way to do this is for a node controlled by the interdicting system to first join the Decentralized Network 604 as a regular client by logging in through client application software provided by or otherwise associated with the Decentralized Network 604, receiving addresses of nodes of the Decentralized Network 604 after logging in, and storing the addresses in a node address cache for later use. The node addresses may be provided in an initial list of node addresses received upon logging in, as well as additional node addresses resulting from connecting to one or more nodes in the initial list of nodes.

The number of the Software Agents SA-1 to SA-N, their attributes as reported to other nodes in the Decentralized Network 604, and the geographical locations of the one or more computers upon which they reside are preferably determined by the number and geographical distribution of the nodes of the Decentralized Network 604 so that the Software Agents SA-1 to SA-N receive a desired percentage of search related communications traveling through the Decentralized Network 604.

Each of the Software Agents SA-1 to SA-N receives search queries from client nodes requesting files in the Decentralized Network 604, and forwards those search queries to other nodes in the Decentralized Network 604 so as to behave just like a regular node in this respect. When the Software Agents SA-1 to SA-N receive search results back from those forwarded search queries, however, rather than passing those search results back along the same path that the Software Agents SA-1 to SA-N received the corresponding search queries, they first send the search results to a Query Matcher 602 implemented as software residing on a computer connected to the Software Agents SA-1 to SA-N through a private network.

The Query Matcher 602 compares each of the references in the search results to entries in its own Database 603 containing metadata including content identification codes of protected files. Matches are then sent back to each of the Software Agents SA-1 to SA-N for search results received by the Query Matcher 602 from that Software Agent.

A Central Coordinating Authority 601 implemented as software on a computer coordinates activities of the plurality of Software Agents SA-1 to SA-N so as to interdict unauthorized copying in the Decentralized Network 604. It does this by sending instructions to the plurality of Software Agents SA-1 to SA-N through a private network specifying actions to be taken when the plurality of Software Agents SA-1 to SA-N receive matches of search results with protected files back from the Query Matcher 602.

Search Result Manipulation

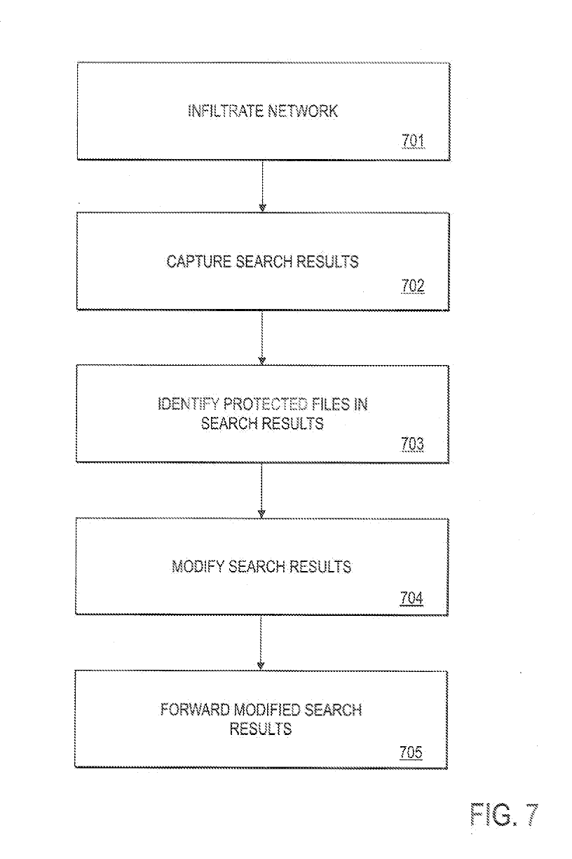

FIG. 7 illustrates a flow diagram of a method for interdicting search queries through search result manipulation. In 701, a Software Agent infiltrates a decentralized network resembling or masquerading as a node along with other Software Agents as described in reference to FIG. 6. The node may be any node in a non-hierarchical network, or it may be a SuperNode in a hierarchical network. In 702, the Software Agent captures search results on their way back to a client node from which its corresponding search string originated.

In 703, the Software Agent identifies files, documents and/or programs that it has been chartered to protect (also referred to herein cumulatively as “protected files”) in the search results. For example, it may do this by sending the search results to a Query Matcher and receiving matches for protected files back from the Query Matcher as previously described in reference to FIG. 6.

In 704, the Software Agent modifies the search results so as to interdict unauthorized copying of the protected files according, for example, to instructions provided to it by a Central Coordinating Authority as previously described in reference to FIG. 6. In 705, the Software Agent then forwards the modified search results through the decentralized network so that it is subsequently received by the client node which originated the corresponding search string.

The Software Agent may employ any one or more of several techniques to modify the search results in 704 so as to interdict unauthorized copying in the decentralized network. In all of these techniques, however, a key feature is that none of the actual files that are residing on nodes in the decentralized network and being made available by those nodes for file sharing are damaged in any way. The techniques only interdict unauthorized copying of protected files in the decentralized network.

One such technique to modify the search results in 704 is to simply delete all or a subset of the references that correspond to matches with protected files in the search results.

Another technique to modify the search results in 704 is to modify information for the references corresponding to matches with protected files so that they point to, for examples, an IP address that is invalid, or an IP address for a computer that does not host the requested content, or an IP address for a computer that is not even running the client application software for the decentralized network.

Another technique to modify the search results in 704 is to modify information for the references corresponding to matches with protected files so that they point to alternative files on their respective host nodes (i.e., nodes identified in the search results as having the protected files available for file sharing). Selection of the alternative files in this case may be made by random or non-random selection of non-protected files (i.e., files, documents or programs that the Software Agent is not chartered to protect).

Another technique to modify the search results in 704 is to modify information for the references corresponding to matches with protected files so that they point to one or more alternative files residing on a Controlled Node. Selection of the alternative files may be made by random or non-random selection of files on a Controlled Node, as long as the alternative files being pointed to are not protected files. The Controlled Node may be a Software Agent or another node that is controlled by the Central Coordinating Authority 601.

Since the node is controlled in this case, there is flexibility in the form and/or content of the alternative file being pointed to. For example, the alternative file may be a synthesized decoy, or another file that is freely distributable, or a rights managed version of the protected file (i.e., one that has added controls and/or features to make it compatible with a digital rights management system).

Synthesis of Decoy Files

Decoys are used to impersonate protected files. In particular, Decoys are files having the same properties such as filename and metadata as the files that they are impersonating, but have different content. Hash values provided by the Decoys, however, generally match their actual content, not the content of the files that they are impersonating. The following describes ways in which decoys can be algorithmically synthesized to impersonate protected audio, video, application, image and document files.

For all file types, the title of the synthesized decoy will be a random combinatorial reordering of words and phrases from the title of the protected file. The mouse over property of the file will be the same as the title.

For audio files, the content can be white noise or an anti-piracy message. The MIME type will be randomly selected from one of the commonly used types for audio (such as wave, or aiff). The length of the file is chosen at random from a range that corresponds to the size range of the known instances of the file on the Network.

For video files, the content will be snow or white noise. The MIME type will be randomly selected from one of the commonly used types for video (such as mpeg, avi, or quicktime). The length of the file is also chosen at random from a range that corresponds to the size range of the known instances of the file on the Network.

For applications, the content will be a “no operation” or NOP executable that simply terminates when executed. The type will be randomly selected from one of the commonly used types (such as ZIP).

For image files, the content will be snow or an anti-piracy statement. The MIME type will be randomly selected from one of the commonly used types for images (such as jpg, tif, or gif). The color depth and resolution are also randomly chosen (e.g., 1600.times.800 resolution, 16 bit depth).

For documents, the content is blank and the MIME type is randomly selected from one of the commonly used types for documents (such as zip, pdf, doc, ppt, rtf, or html).

As just one example, the algorithmically synthesized decoy for a protected audio file for Madoima's Ray of Life track could include a title Ray of Life Track by Madonna. The content of the file, however, could be just white noise. The MIME type could be mp3 (or any of the common audio mime types) and the length of the audio file could be 3.5 minutes. Mouse over on the decoy would display the file title which would closely match the title of the protected file.

In addition to, or in lieu of, modifying the search results in 704, the interdiction system of the present invention may also perform other activities for interdicting unauthorized copying in a decentralized network.

Nodal Quarantining

One such activity is nodal quarantining, wherein a node to be quarantined is surrounded with Software Agents by, for example, the Central Control Authority 601. Using nodal quarantining, a node that is identified as having protected files available for file sharing can be effectively eliminated from the decentralized network by making it “invisible” to other nodes on the decentralized network or its file sharing activity restricted, but not completely eliminated, so as to interdict unauthorized copying of protected files while allowing it to share non-protected files with other nodes in the decentralized network.

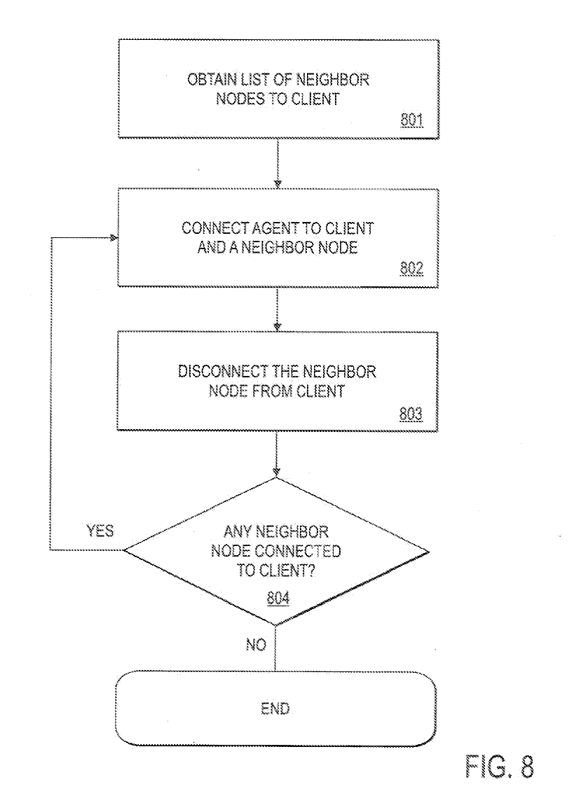

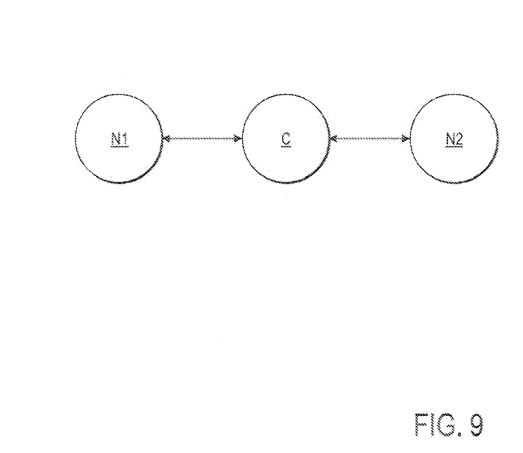

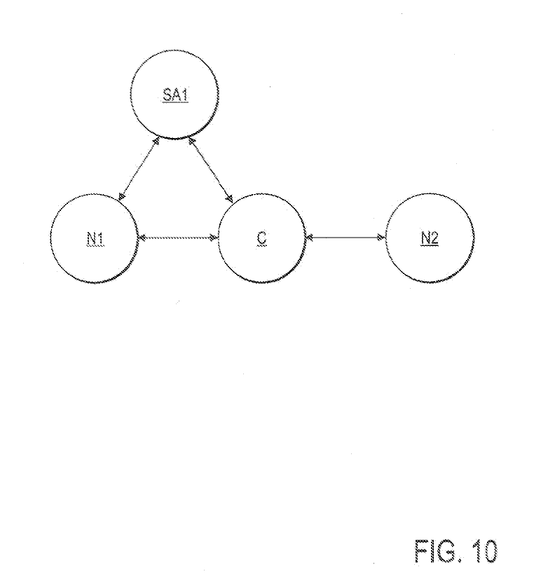

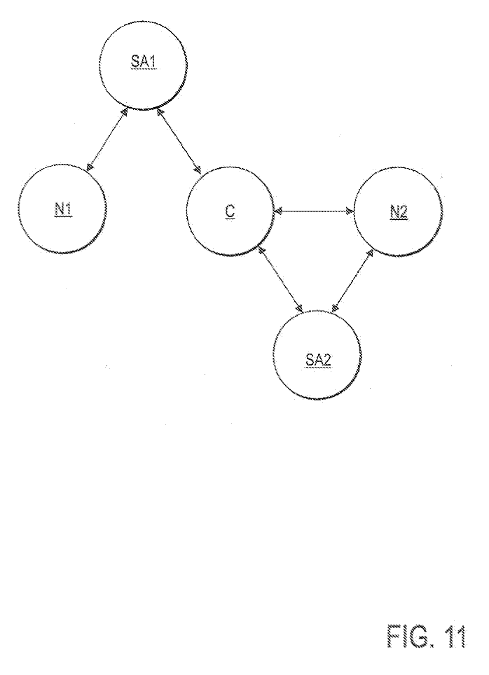

FIG. 8 illustrates a flow diagram of a method for quarantining a node, and FIGS. 9-12 illustrate a simple step-by-step example of the method using node diagrams. In 801, after identifying a node C to be quarantined, a list of its immediate neighbor nodes, N1 and N2, is obtained from that node (FIG. 9). In 802, a Software Agent SA1 is connected to a neighbor node N1 and the node C (FIG. 10). In 803, that neighbor node N1 is then disconnected from the node C (left side of FIG. 11).

Depending upon the capabilities and protocol of the decentralized network, the neighbor node N1 may be disconnected using any one of numerous different techniques such as:

1) issuing a “Disconnect from node C” message to node N1, or vice versa;

2) issuing a “Disconnect from the Network” message to node N1;

3) issuing a message to node C, purporting to be from the neighbor node N1, indicating that node N1 is now disconnecting, or vice versa;

4) issuing a message to node N1 that violates the agreed upon connection protocol between node N1 and node C, thus inducing node N1 to abandon the connection, or vice versa;

5) attaching a very large number of Software Agents to node C so that its capacity or quota of immediate neighbors is exceeded, thus inducing node C to disconnect from one or more of its immediate neighbor nodes until node N1 is disconnected;

6) attaching a very large number of Software Agents to node C so that its capacity or quota of immediate neighbors is exceeded, thus inducing node C to transfer connections for one or more of its immediate neighbor nodes to a single neighbor node until node N1 is disconnected from node C;

7) overwhelming the capacity of node C's port, socket or connection to node N1 by bombarding it with messages or requests that it must parse, act upon, or otherwise process; or

8) eliminating or disconnecting N1 from the decentralized network altogether by exploiting a known defect in the client software application for the decentralized network or underlying client operating system running on the node N1 (e.g., overrun the stack).

It is noted with regards to this last disconnect technique that documentation of such bugs is available in the public domain, albeit ephemerally, for most software clients of popular, large-scale distributed networks.

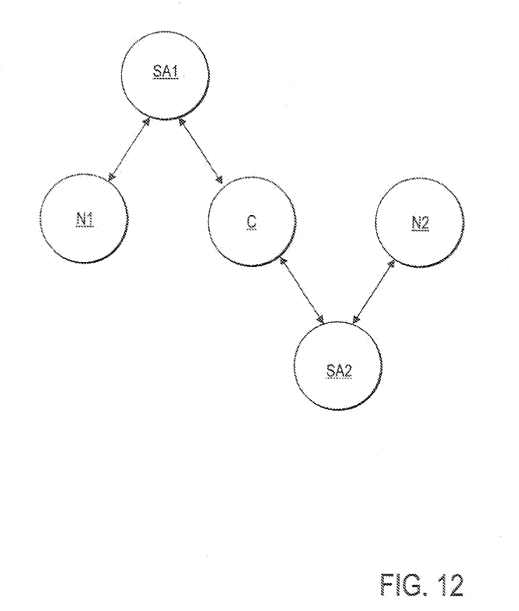

In 804, the method determines whether there is a neighbor node that is still directly connected to the node to be quarantined. In this example, the answer is YES, so the method loops back to 802, and another Software Agent SA2 is connected to a neighbor node N2 and the node C (right side of FIG. 11). In 803, the neighbor node N2 is then disconnected from the node to be quarantined (FIG. 12). Then again in 804, the method determines whether there is another neighbor node connected to the node to be quarantined. This time, however, the answer is NO, so the method terminates.

File Impersonation

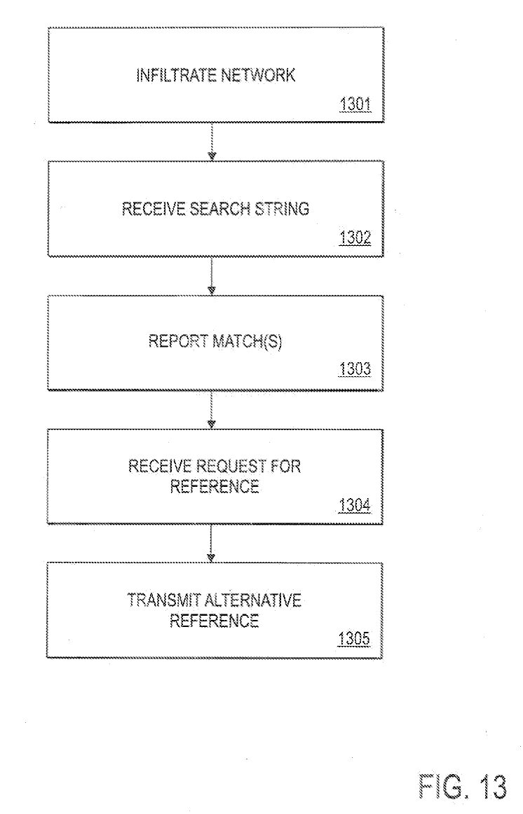

Another activity for interdicting unauthorized copying in a decentralized network is file impersonation. For example, FIG. 13 illustrates a flow diagram of a method for interdicting unauthorized copying in a decentralized network through file impersonation. In 1301, a Software Agent infiltrates a decentralized network resembling or masquerading as a node along with other Software Agents as described in reference to FIG. 6. The node in this case may be any type of node in either a non-hierarchical or hierarchical decentralized network. In 1302, the Software Agent receives a search string just like other nodes in the decentralized network, and in 1303, it reports matches for protected files satisfying the search string along with attributes that would qualify it as a top choice or source for the matches in the decentralized network.

In 1304, the Software Agent receives a request for one of the reported matches, and in 1305, it sends an alternative file instead of the actually requested file. The alternative file in this case may be a synthesized decoy file, or a spoof file, or a file that is freely distributable, or a rights-managed version of the matched protected file.

File Transfer Attenuation

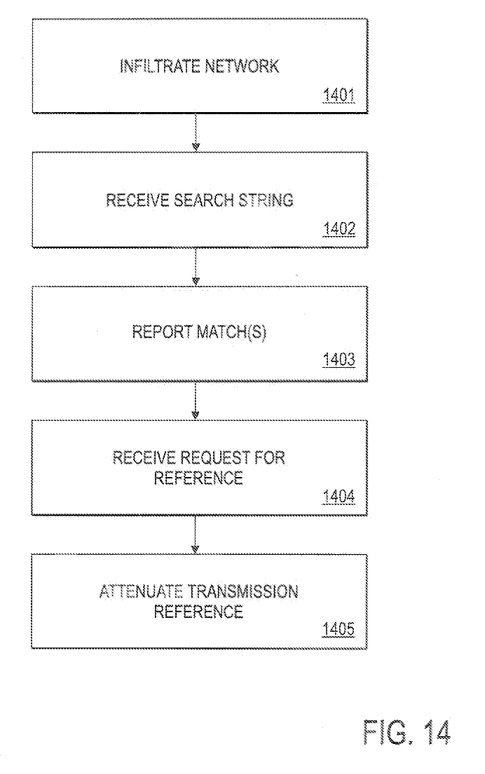

Another activity for interdicting unauthorized copying in a decentralized network is file transfer attenuation. For example, FIG. 14 illustrates a flow diagram of a method for interdicting unauthorized copying in a decentralized network through file transfer attenuation, wherein 1401 to 1404 are performed in the same manner as described in reference to 1301 to 1304. In 1405, however, in addition to transmitting an alternative file, the method attenuates the transmission so that its transmission rate starts off fast, then as the download goes on, the transmission rate slows down. By the time the transmission rate slows down a lot, the user of the client node requesting the file has got most of the file so he or she will be reluctant to cancel the download at that point. Eventually, however, the transmission rate will slow down to such a trickle that the user will probably become extremely unhappy with the download progress and consequently, cancel it at that point. In this case, the download will not time out so the user must explicitly cancel it in order to terminate the transmission. Alternatively, the transmission may be automatically terminated after a certain percentage such as 95% of the file has been transmitted.

Another technique for interdicting unauthorized copying in a decentralized network is hash spoofing. Although discussed separately here, forms of hash spoofing can also be used in the search results modification method described in reference to FIG. 7 as well as the file impersonation method described in reference to FIG. 13.

Hash Spoofing

In most decentralized peer-to-peer file sharing networks, whether hierarchical or non-hierarchical, each unique file is given an identification code to uniquely identify its content. Commonly, this code is a hash value generated through a cryptographic hash algorithm (such as MD-4, MD-5, SHA-1, SHA-64, etc.) of all or a subset of the file's content. This hash mechanism is used by some decentralized networks to facilitate resuming downloads which have been interrupted for some reason before completion, or for multi-source downloading which can be used to greatly improve the reliability and speed of file downloads.

A client node sends out a search string on a decentralized network, and gets search results back along with their hashes. The file that the user of the client node wishes to download, may reside on more than one node in the decentralized network as evidenced by identical hashes. If the client node has its download interrupted for some reason, it may resume its download at a later time by finding another node having the file as identified by an identical hash value, and downloading the rest of the file at that time from that node. In addition, if the client node wants to download a file with many sources on the decentralized network and it knows that all of these sources have exactly the same content (as evidenced by their same hash values), the client node can split the file content into segments and request a few segments from each of the sources.

Once the downloads are completed, the client node then can verify that the hash given to it in the search results is identical to the hash calculated using the file content that was downloaded. If the two match, then downloading was successful. On the other hand, if they do not match, then the downloaded file is said to be corrupt, and the client node will either automatically delete it or flag it as corrupt and ask the user what to do with it.

Hash spoofing can be used for interdicting unauthorized copying where such interruption/resumption and multi-source downloading is being used in a decentralized network. In the interdiction method described in reference to FIG. 7, the Software Agent may modify the search results so as to replace a link to (or address of) a file to be protected with either a link to a non-existent file along with a reported hash value that doesn't correspond to any file in the decentralized network, or a link to a spoof file along with a reported hash value matching that of the file whose link is being replaced. In the first case, the client node will try to find the non-existent file, but will be unsuccessful, because the file doesn't exist. The client node may also try to find other files with the same hash value as the non-existent file for download, but will never be able to since there are no files in the decentralized network that correspond to the hash value.

In the second case, when the Software Agent receives a request for a protected file, or a segment of the protected file in the case of a multi-source download, the spoof file or a portion thereof is transmitted instead of the requested file or segment of the file. After the client node has completed downloading the file, or all segments from its sources in the case of multi-source downloading, the hash will be calculated and a mismatch will be detected at that time (i.e., the file will be corrupted), because the hash value of the spoof file or segment thereof is different than that reported.

Multi-Level and/or Demand Based Interdiction

Although it is possible to perform all of the interdiction methods described herein simultaneously for maximum effect, such an approach may be an inefficient use of system resources as well as commercially impractical from a cost/benefit perspective. Further, some interdiction methods may be most advantageous under certain situations, while other interdiction methods are most advantageous in others.

For example, one commonly used interdiction approach is to flood a decentralized network with decoys of a protected file. This approach may be very effective when there is a large demand for the protected file. However, it can also be wasteful of system resources when the demand for the protected file is small, since a large number of controlled nodes offering the decoys for downloading in the decentralized network must be provided in order to effectively flood the network with decoys, making this approach not easily scaleable.

Conversely, some of the interdiction approaches described herein, such as search result manipulation, are readily scaleable, and therefore, are very cost effective even when demand for a protected file is small. These approaches are especially useful for protecting large catalogues of protected files where demand for individual files may vary considerably from one to another in the catalogue. Thus, a multi-level and/or demand based approach of using one or more interdiction techniques under certain circumstances, and other interdiction techniques under other circumstances can be readily appreciated for its usefulness in cost effectively interdicting unauthorized copying of protected files in a decentralized network.

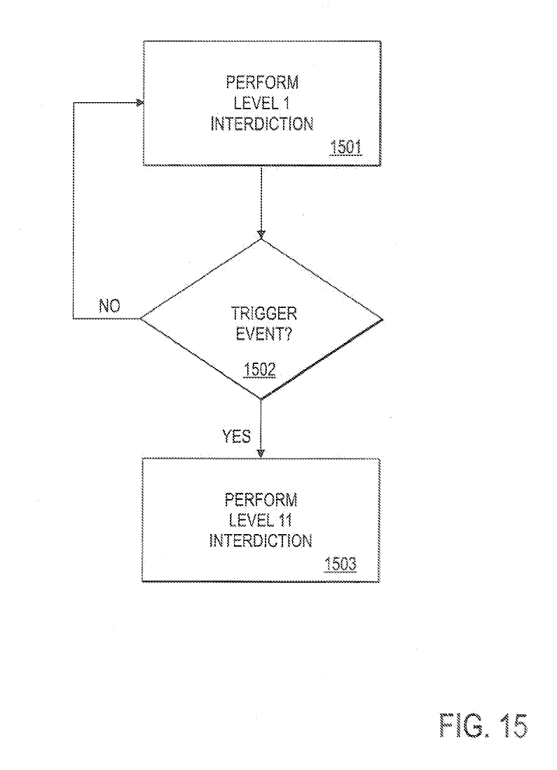

FIG. 15 illustrates, as an example, a general approach to a multi-level and/or demand based method for interdicting unauthorized copying in a decentralized network. In 1501, a first level of interdiction is performed to interdict unauthorized copying of protected files in a decentralized network. In 1502, a trigger event is detected while performing the first level of interdiction. The trigger event may be related to a number of search results being sent back to one of the decentralized network nodes indicating a file that is to be protected through the first level of interdiction, or a number of search queries originating from the node indicating a file that is to be protected through the first level of interdiction. In 1503, a second level of interdiction is performed in response to the detection of the trigger event. The second level of interdiction may include tasks performed in addition to those of the first level of interdiction, or tasks performed in lieu of those performed in the first level of interdiction. Although only two levels of interdiction are shown in this particular example, it is to be appreciated that additional levels of interdiction could be added with each additional level being triggered by a different trigger event.

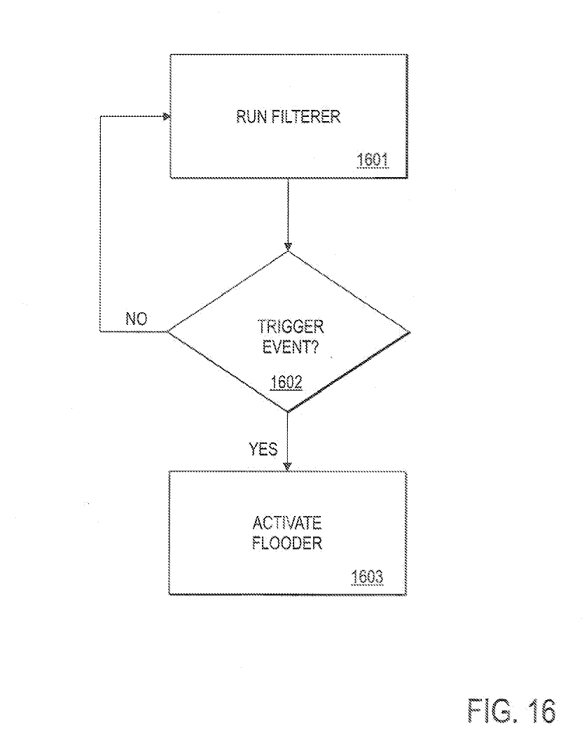

FIG. 16 illustrates, as an example, a particular and preferred multi-level and/or demand based method for interdicting unauthorized copying in a decentralized network. In 1601, a Filterer module is run along with or as a part of a software agent masquerading as a node in the decentralized network so as to perform search result manipulation such as described in reference to FIG. 7.

In 1602, a trigger event is detected by the software agent while performing the search result manipulation. The trigger event in this case is related to a number of times a protected file is referenced in search results being transmitted back to one of the nodes of the decentralized network. More particularly, the trigger event is detected when that number exceeds a threshold number programmed into or provided to the software agent.

In 1603, a Flooder module included with or in the software agent is activated that causes the node identified in 1602 to be flooded with decoys of the protected file. Note that this is a selective flooding directed to a specific node of the decentralized network, as opposed to conventional flooding that is directed to the entire decentralized network. Because it is a selective or targeted flooding, as opposed to a shotgun flooding, it is to be appreciated that it is a far more efficient interdiction approach with respect to the utilization of system resources.

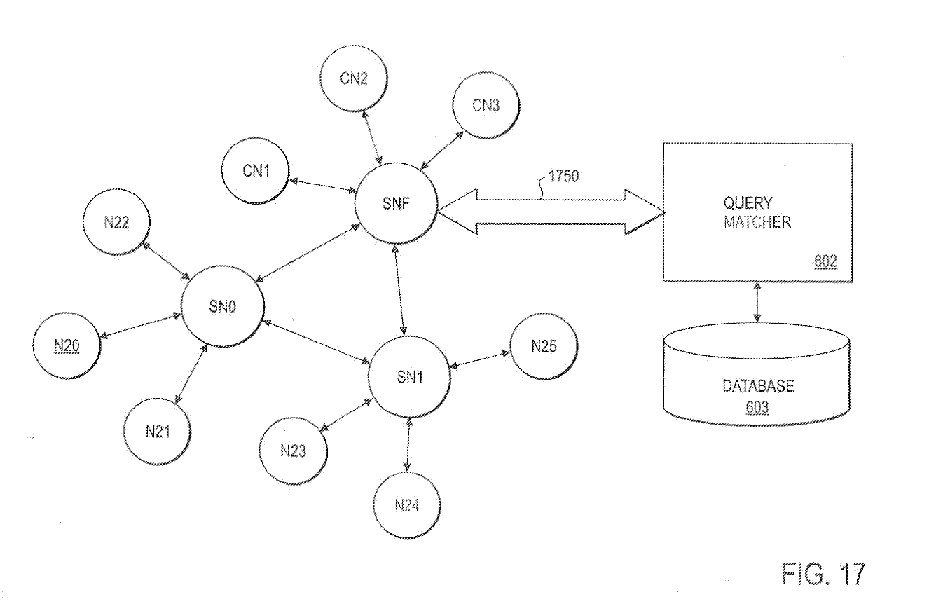

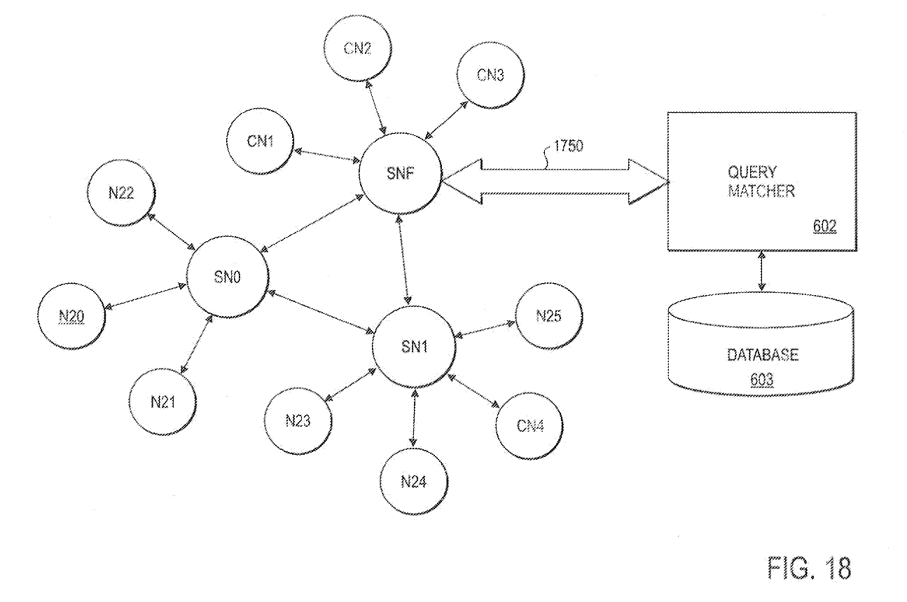

FIGS. 17 and 18 illustrate, as an example, the operation of 1601 to 1603 in a hierarchical decentralized network. Referring first to FIG. 17, a Software Agent “SNF” performs the task of a filterer such as described in reference to 1601, while masquerading as a SuperNode in the decentralized network so as to intercept communications within the decentralized network related to search queries.

During the performance of its interdiction tasks, the Software Agent “SNF” identifies references to protected files in the communications by interacting with a Query Matcher 602 as described in reference to FIG. 6. When the number of times that a reference to one of the protected files exceeds a threshold number for one of the other SuperNodes in the decentralized network, a trigger event is detected by the Software Agent “SNF”. In the present example, it is assumed that SuperNode “SN1” has been identified as being associated with the trigger event.

Referring now to FIG. 18, in response to the detection of the trigger event, a Flooder module included with or in the Software Agent “SNF” is activated. The Flooder module floods the identified SuperNode “SN1” with decoys of the protected file by, for example, connecting one or more controlled nodes, such as Controlled Node “CN4”, as regular nodes to the SuperNode “SN1”, wherein each of the controlled nodes has one or more decoys of the protected file available for downloading. Note that these nodes are referred to as controlled nodes since they are controlled by or under common control as the Software Agent “SNF”.

By continuously looping through and applying 1601 to 1603, the Software Agent “SNF” can selectively flood any SuperNode in the decentralized network with decoys of any protected file in a catalog of protected files after a trigger event has identified that SuperNode and that protected file as needing the additional protection afforded by such selective flooding. Although not shown in the figures, a reverse procedure may also be used wherein selective flooding is stopped when the trigger event is no longer being triggered (i.e., when the number of times that a reference identifying the protected file and included in communications associated with a given SuperNode falls below the threshold number).

Still other techniques for interdicting unauthorized copying in a decentralized network using the plurality of Software Agents, Central Coordinating Authority, and Query Matcher as described herein can also be readily conceived and are fully contemplated to be within the full scope of the present invention.

Advertisement Tracking and Optimization

One embodiment of the present invention relates to the tracking and optimization of advertisements on a decentralized network. More specifically, one embodiment of the present invention provides a system and method to track the effectiveness of monetization efforts on a decentralized network such as a peer-to-peer network, and to use information regarding users on the decentralized network to optimize further monetization efforts for maximum revenue generation.

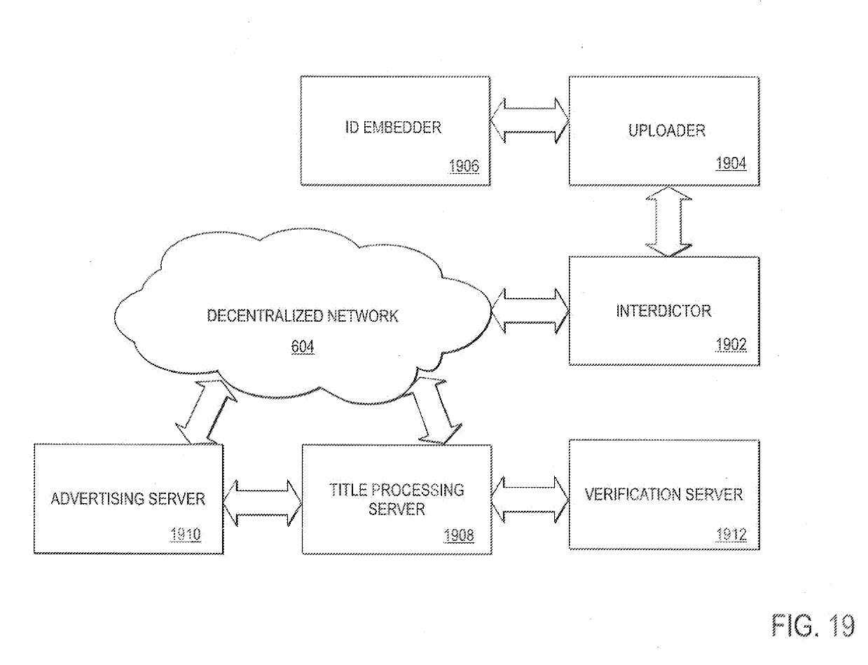

FIG. 19 illustrates an exemplary system for tracking and optimizing advertisements on a decentralized network. An interdictor 1902 is coupled to decentralized network 604. Interdictor 1902 is configured to receive user searches on decentralized network 604 and return a one or more files matching the user search queries found in an uploader 1904. An ID embedder 1906 is configured to embed an identifier on the files stored in uploader 1904. An title processing server 1908 is also coupled to decentralized network 604. If a user on decentralized network 604 executes a file provided by interdictor 1902, title processing server 1908 is configured to retrieve the identifier embedded in the file and provide the embedded identifier to an advertising server 1910. Advertising server 1910 is also coupled to decentralized network 604 and is configured to provide advertisements matching the embedded identifier to the user, if a verification server 1912 verifies that the file was directly downloaded from the interdiction system instead of from another node in decentralized network 604.

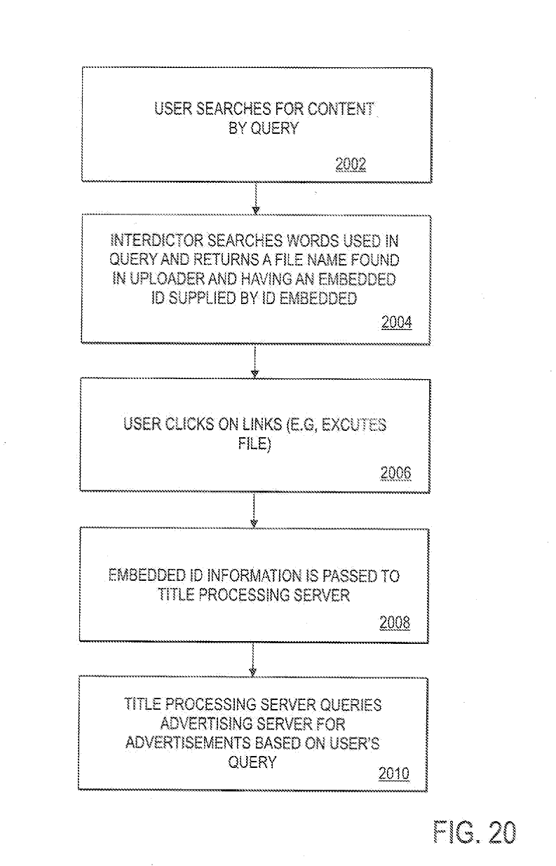

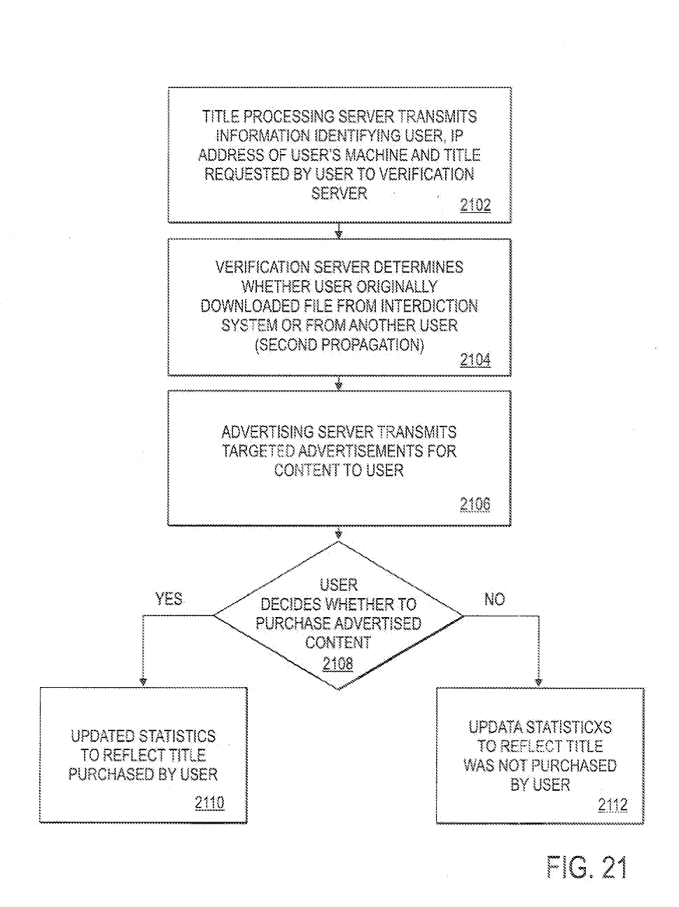

FIGS. 20 and 21 illustrate an exemplary process in which monetization on a decentralized network can be tracked and optimized. In 2002, a user on decentralized network 604 searches for content on decentralized network 604 by using a query such as “Britney Spears poster.” In 2004, interdictor 1902 searches words used in the query and returns a file name found in uploader 104 and having an embedded identifier supplied by ID embedder 1906. For example, the embedded identifier may be the query parameter “23456 Britney%20Spears%20Poster.” In 2006, after the file retrieved from uploader 1904 is provided to the user, the user executes the file, for example, by clicking a link in the file. In 2008, after the user executes the file (e.g., a link is clicked and a website is browsed), the embedded identifier is provided to title processing server 1908. In 2010, title processing server 1908 queries advertising server 1910 for advertisements matching the user's query. In one embodiment of the invention, the file transmitted to the user is configured to redirect the user to a uniform resource locator (“URL”) containing the parameters of the query provided by the user to request the file.

In 2102, title processing server 1908 transmits information identifying the user, IP address of the user's computer, and advertisement title requested by the user to verification server 1912. In 2104, verification server 1912 determines whether the user originally downloaded the file from the interdiction system or from another node or user on decentralized network 604. If the file was not originally downloaded from the interdiction system (i.e., second propagation), then full advertised content may not be provided to the user. Thus, in 2106, if verification server 1912 determines that the file was downloaded directly from the interdiction system, advertising server 1910 transmits targeted advertisements to the user. In 2108, the user decides whether or not to purchase the advertised content. If the user decides to purchase the advertised content, statistics reflecting the title purchased by the user is updated in 2110. If the user decides not to purchase the advertised content, statistics reflecting that the title was not purchased by the user is updated in 2112.

In one embodiment of the invention, the identifier embedded in the file is unique to the user and/or the user request for file. For example, the user's username on decentralized network 604 may be embedded in the file provided to the user. This way, one embodiment of the present invention allows the tracking of the user's behavior on decentralized network 604. Possible user behaviors that can be tracked, among others, are 1) the decentralized network that the user found the file on, 2) the exact search criteria that the user used, 3) the date and time that the user found the file, 4) the user's geographical location (e.g., using the user computer's IP address), 5) the type of connection that the user has and its approximate speed, 6) statistics on the user's usage of the decentralized network, including how many files that the user is sharing, and 7) ability to browse the user's shared files. With the embedded identifier, embodiments of the present invention also can track 1) how long it took the user to complete the download, 2) when the user clicked or executed the file, 3) what the user did afterwards (e.g., sale, action, browsed website, etc.), and 4) the ability to browse the user's shared files at a later time, for example, to see if the user has deleted the downloaded file from the shared folder. With these statistics available per user, embodiments of the invention allow the detection of who is the best user to target an advertisement. For example, if the statistics show that user A is more likely to perform the end action or sale than user B, one embodiment of the invention allows the prioritizing to target user A for advertisements rather than user B.

One embodiment of the present invention also provides the optimization of monetization efforts on a decentralized network. For example, a number of metrics, such as what advertisement titles to share, how many advertisement titles to share, the number of connections and bandwidth to allow for uploading per advertisement title, and the bandwidth to allow a giver user to download a given advertisement title, can be adjusted and optimized. To decide what titles to share on decentralized network 604, user queries being transmitted on decentralized network 604 as well as queries results are matched against the advertisement inventory stored in advertising server 1910. Titles matching the highest number of user queries and query results are chosen to provide to users on decentralized network 604.

To decide how many of each advertisement title to share on decentralized network 604 and the number of connections and bandwidth to allow for uploading per title, one embodiment of the invention tracks the revenue a particular title generates. Resources can be adjusted in accordance with the revenue that each title is generating. For example, if title A has 50% of resources and generates 99% of the revenue, and title B has 50% of resources and generates 1% of the revenue. Then the resources can be reallocated such that title A is provided with 99% of the resources and title B is provided with 1% of the resources. The resource reallocation can be done periodically. Specifically, it may be desirable to move toward the resource usage suggested gradually to account for day to day variations.

The bandwidth to allow a given user to download a particular title can be determined based on past data. When a user requests to download a file from the interdiction system, some information about the user can be derived, such as the user's geographical location, the file that the user requests, the keywords that the user used to find the file, and the approximate speed and the type of the user's connection. Based on this information, one embodiment of the invention look at past similar users, and determine the probability that the past users will initiate a sales transaction or a follow-up action. This probability can be used to allocate similar users a specific amount of the system's resources.

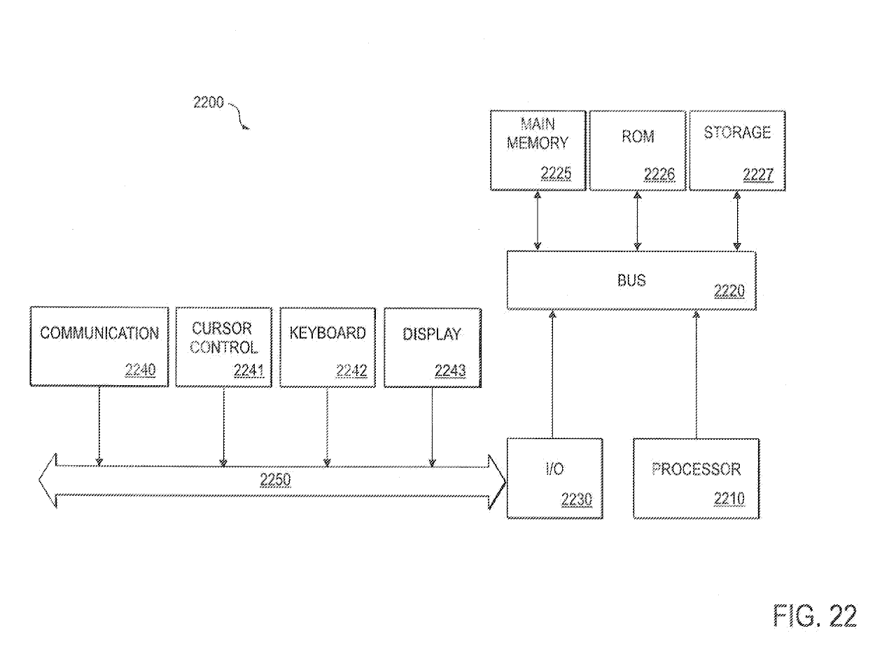

FIG. 22 illustrates an exemplary computer architecture for use with the present system, according to one embodiment. Computer architecture 2200 can be used to implement the computer systems described in various embodiments of the invention. One embodiment of architecture 2200 comprises a system bus 2220 for communicating information, and a processor 2210 coupled to bus 2220 for processing information. Architecture 2200 further comprises a random access memory (RAM) or other dynamic storage device 2225 (referred to herein as main memory), coupled to bus 2220 for storing information and instructions to be executed by processor 2210. Main memory 2225 also may be used for storing temporary variables or other intermediate information during execution of instructions by processor 2210. Architecture 2200 also may include a read only memory (ROM) and/or other static storage device 2226 coupled to bus 2220 for storing static information and instructions used by processor 2210.

A data storage device 2227 such as a magnetic disk or optical disc and its corresponding drive may also be coupled to computer system 2200 for storing information and instructions. Architecture 2200 can also be coupled to a second I/O bus 2250 via an I/O interface 2230. A plurality of I/O devices may be coupled to I/O bus 2250, including a display device 2243, an input device (e.g., an alphanumeric input device 2242 and/or a cursor control device 2241). For example, web pages and business related information may be presented to the user on the display device 2243.

The communication device 2240 is for accessing other computers (servers or clients) via a network. The communication device 2240 may comprise a modem, a network interface card, a wireless network interface or other well known interface device, such as those used for coupling to Ethernet, token ring, or other types of networks.

Although the present method and system have been described in connection with a decentralized network, one of ordinary skill would understand that the techniques described may be used in any situation where it is to track and optimize advertisements on a network.

A method and system for tracking and optimizing advertisements on a decentralized network. In one embodiment, the method comprises receiving a request for a user from a user on a network. The method further comprises responding to the request by transmitting the file to the user, the file containing an identifier. The identifier is used to track the user's treatment of the file.

I claim:

1. A computer-implemented method, comprising:
receiving a request for a user from a user on a network;
responding to the request by transmitting the file to the user, the file containing an identifier; and
using the identifier to track the user's treatment of the file.

2. The computer-implemented method of claim 1, wherein the identifier is used to determine if a sale was made as a result of the user's treatment of the file.

3. The computer-implemented method of claim 1, wherein the identifier is used to determine if a website was browsed as a result of the user's treatment of the file.

4. The computer-implemented method of claim 1, wherein the identifier is used to determine if the user executed the file.

5. The computer-implemented method of claim 1, wherein the identifier is used at a later time to determine if the user has deleted the file from a shared folder.

6. The computer-implemented method of claim 1, further comprising targeting the user with advertising based on the user's treatment of the file.

7. The computer-implemented method of claim 1, wherein the identifier is unique to the user and the request.

8. The computer-implemented method of claim 1, wherein the identifier comprises a query provided by the user to request the file.

9. The computer-implemented method of claim 1, wherein the file transmitted to the user redirects the user to a link containing the parameters of a query provided by the user to request the file.

10. The computer-implemented method of claim 1, wherein the file transmitted to the user further comprises the user's nickname.

11. A computer-readable medium having stored thereon a plurality of instructions, said plurality of instructions when executed by a computer, cause said computer to perform:
receiving a request for a user from a user on a network;
responding to the request by transmitting the file to the user, the file containing an identifier; and
using the identifier to track the user's treatment of the file.

12. The computer-readable medium of claim 1, wherein the identifier is used to determine if a sale was made as a result of the user's treatment of the file.

13. The computer-readable medium of claim 11, wherein the identifier is used to determine if a website was browsed as a result of the user's treatment of the file.

14. The computer-readable medium of claim 11, wherein the identifier is used to determine if the user executed the file.

15. The computer-readable medium of claim 11, wherein the identifier is used at a later time to determine if the user has deleted the file from a shared folder.

16. The computer-readable medium of claim 11, wherein the computer further performs targeting the user with advertising based on the user's treatment of the file.

17. The computer-readable medium of claim 1, wherein the identifier is unique to the user and the request.

18. The computer-readable medium of claim 1, wherein the identifier comprises a query provided by the user to request the file.

19. The computer-readable medium of claim 11, wherein the file transmitted to the user redirects the user to a link containing the parameters of a query provided by the user to request the file.

20. The computer-readable medium of claim 1, wherein the file transmitted to the user further comprises the user's nickname.

21. A computer system, comprising:
a processor; and
memory coupled to the processor, the memory storing instructions;
wherein the instructions when executed by the processor cause the processor to:
receive a request for a user from a user on a network;
respond to the request by transmitting the file to the user, the file containing an identifier; and
use the identifier to track the user's treatment of the file.

22. The computer system of claim 21, wherein the identifier is used to determine if a sale was made as a result of the user's treatment of the file.

23. The computer system of claim 21, wherein the identifier is used to determine if a website was browsed as a result of the user's treatment of the file.

24. The computer system of claim 21, wherein the identifier is used to determine if the user executed the file.

25. The computer system of claim 21, wherein the identifier is used at a later time to determine if the user has deleted the file from a shared folder.

26. The computer system of claim 21, wherein the instructions when executed by the processor further cause the processor to target the user with advertising based on the user's treatment of the file.

27. The computer system of claim 21, wherein the identifier is unique to the user and the request.

28. The computer system of claim 21, wherein the identifier comprises a query provided by the user to request the file.

29. The computer system of claim 21, wherein the file transmitted to the user redirects the user to a link containing the parameters of a query provided by the user to request the file.

30. The computer system of claim 21, wherein the file transmitted to the user further comprises the user's nickname.
